(19) United States
(12) Patent Application Publication
(10) Pub. No.: US 2004/0266437 A1
(43) Pub. Date: Dec. 30, 2004

(54) Method and system for providing mobile handover across multiple media gateways controlled by the same call server

(75) Inventors: Brahmananda Vempati, Dallas, TX (US); Jianming Xu, Plano, TX (US)

Correspondence Address: HAYNES AND BOONE, LLP, 901 MAIN STREET, SUITE 3100, DALLAS, TX, 75202, US

(73) Assignee: Spatial Communication Technologies, Inc., Richardson, TX (US)

(21) Appl. No.: 10/827,154

(22) Filed: Apr. 19, 2004

Related U.S. Application Data
(60) Provisional application No. 60/463,559, filed on Apr. 17, 2003.

(51) Int. Cl. H04Q 7/20

(52) U.S. Cl. 455/436; 455/439; 455/438

(57) ABSTRACT

The present disclosure describes a system and method for handing off a mobile device from ananchor wireless media gateway (WMG) to a target WMG, where both WMGs are controlled by a single call server. In one example, the anchor WMG includes first and second termination points connecting the first WMG to the mobile device and another party, respectively. The method includes creating fourth and fifth termination points in the target WMG to provide an interface for the target WMG to communicate with the mobile device and the anchor WMG, respectively. A third termination point may be established in the anchor WMG, and the third and fifth termination points may link the first and second WMGs. A context may be created using the second and third termination points, and the third termination point may be made bi-directional.

### CROSS-REFERENCE

This application claims priority from U.S. Provisional Patent Application Ser. No. 60/463,559, filed on Apr. 17, 2004, the entire disclosure of which is hereby incorporated by reference as if reproduced in its entirety.

### BACKGROUND

The present disclosure relates generally to voice and data communications and, more particularly, to a wireless system and method for providing handover to a wireless mobile serviced by a wireless soft-switch.

A wireless network is generally composed of two sub-networks: a Radio Access Network (RAN) which handles radio related issues such as managing and assigning radio resources to a mobile, and a Core Network (CN) which links a mobile user to a wireline network. Due to wireless coverage limitations in each RAN, a mobile moving outside the boundaries of a RAN must switch its service over to a neighboring RAN to avoid service disconnection. This process is known as handoff and, as a result of this process, the service handling may be switched over from the network entities in the old RAN and CN (the “serving” entity), to the new RAN and CN (the “target” entity).

In some networks using softswitch technology for wireless applications, call control and bearer functionality may be split between a call server and a wireless media gateway (WMG). For example, the call server may control the WMG (e.g., may handle call related control signaling), while the WMG may handle the bearer related tasks. Handover may occur between different call servers. However, difficulties may arise when a call server controls multiple WMGs, and a mobile device needs to switch from one of the controlled WMGs to another of the controlled WMGs.

Accordingly, what is needed is a method and system to provide a handoff solution between two WMGs controlled or serviced by the same call server.

### BRIEF DESCRIPTION OF THE DRAWINGS

FIG. 1 illustrates an exemplary network architecture in which a handoff may occur from one wireless media gateway (WMG) to another WMG controlled by the same call server.

FIG. 2 illustrates an exemplary call flow diagram that may be executed within the architecture of FIG. 1 where the WMGs are linked by a time division multiplexing bearer connection.

FIGS. 3a-3f illustrate exemplary termination points that may be used during the execution of the method of FIG. 2.

FIG. 4 illustrates an exemplary call flow diagram that may be executed within the architecture of FIG. 1 where the WMGs are linked by an asynchronous transfer mode bearer connection.

FIG. 5 illustrates an exemplary call flow diagram that may be executed within the architecture of FIG. 1 where the WMGs are linked by an internet protocol bearer connection.

FIG. 6 illustrates an exemplary network architecture in which a handoff may occur between three WMGs controlled by the same call server.

FIGS. 7a-7c illustrate exemplary termination points that may be used for a handoff in the architecture of FIG. 6.

### WRITTEN DESCRIPTION

The present disclosure relates generally to voice and data communications and, more particularly, to a wireless system and method for providing handover to a wireless mobile serviced by a wireless soft-switch.

It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

For the purposes of illustrating the present disclosure, various acronyms may be used, the definitions of which are listed below:

| | |
|---|---|
| ACK | Acknowledgment |
| ATM | Asynchronous Transfer Mode |
| BICC | Bearer Independent Call Control |
| BSC | Base Station Centre |
| BSS | Base Station System |
| BTS | Base station Transceiver System |
| GMSC | Gateway MSC |
| GSM | Global System for Mobile communications |
| HLR | Home Location Register |
| HO | Handoff |
| IP | Internet Protocol |
| IS41 | Wireless Network conforming to the IS41 standard |
| ISDN | Integrated Services Digital Network |
| ISUP | ISDN User Part (of SS7) |
| IVR | Interactive Voice Response |
| MEGACO | Media Gateway Control |
| MS | Mobile Station |
| MSC | Mobile Switching Center |
| PSTN | Public Switch Telephone Network |
| SMS-C | Short Message Service Center |
| SS7 | Signaling System No. 7 |
| T1 | Digital communication line that uses time |
| | division multiplexing with an overall |
| | transmission rate of 1.544 million bits per second. |
| TCP/IP | Transmission Control Protocol/Internet Protocol |
| TDM | Time Division Multiplexing |
| VoIP | Voice over IP |
| VoATM | Voice over ATM |
| WMG | Wireless Media Gateway |
| WSS | Wireless Soft Switch |

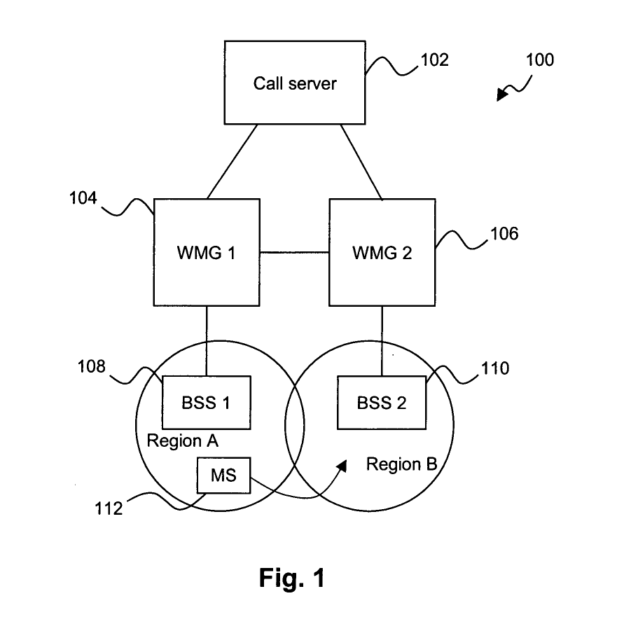

Referring to FIG. 1, in one embodiment, an exemplary network architecture 100 for a wireless network using a wireless softswitch is illustrated. It is understood that the softswitch may contain legacy mobile switching center (MSC) functionality that is split between a call server 102 and one or more wireless media gateways (WMGs) 104, 106. For example, the concept of the softswitch may be based on splitting the control from the bearer path and having a different network entity handle each path. With this analogy, the call server is the network entity that controls the WMG and handles all call related control signaling, management, and maintenance functions. Exemplary functions include call processing, call control, signaling, call features, media gateway control, mobility management, and FCAPS (Faults, Configuration, Accounting, Performance, Security). The WMG is the network entity that is controlled by the call server and handles all the bearer related tasks, such as bearer setup, bearer path management, context management, conference bridging, echo cancellation, silence suppression, and coding/decoding.

In the present example, the call server 102 may serve two regions A and B. The call server 102 may be connected to other call servers (not shown) using a signaling protocol such as BICC. Each region A, B may be serviced by a WMG 104, 106, respectively, that may be connected to the call server 102 using a signaling interface such as MEGACO. Each WMG 104, 106 may be connected to a base station subsystem (BSS) 108, 110, respectively, using an interface such as an A interface, which is a standard GSM Radio Access Network Interface. The WMGs 104, 106 may be connected to each other using a variety of connections, including IP, ATM, and/or TDM connections.

In order for a mobile device 112 (e.g., a cell phone) to move from Region A to Region B, an intra-call server inter-WMG handoff is needed (because both regions are serviced by different WMGs that are connected to the same call server). In such a handoff, the WMG 104 may be referred to as the “serving” WMG, and the WMG 106 may be referred to as the “target” WMG. As will be described in greater detail below, after the handoff is completed, the voice path will go through the serving WMG 104 towards the target WMG 106. Accordingly, the serving WMG 104 is known as the “anchor” WMG because it forwards the voice connection from the original connection point (e.g., Region A) to the new WMG in the region where the mobile device is located (e.g., Region B).

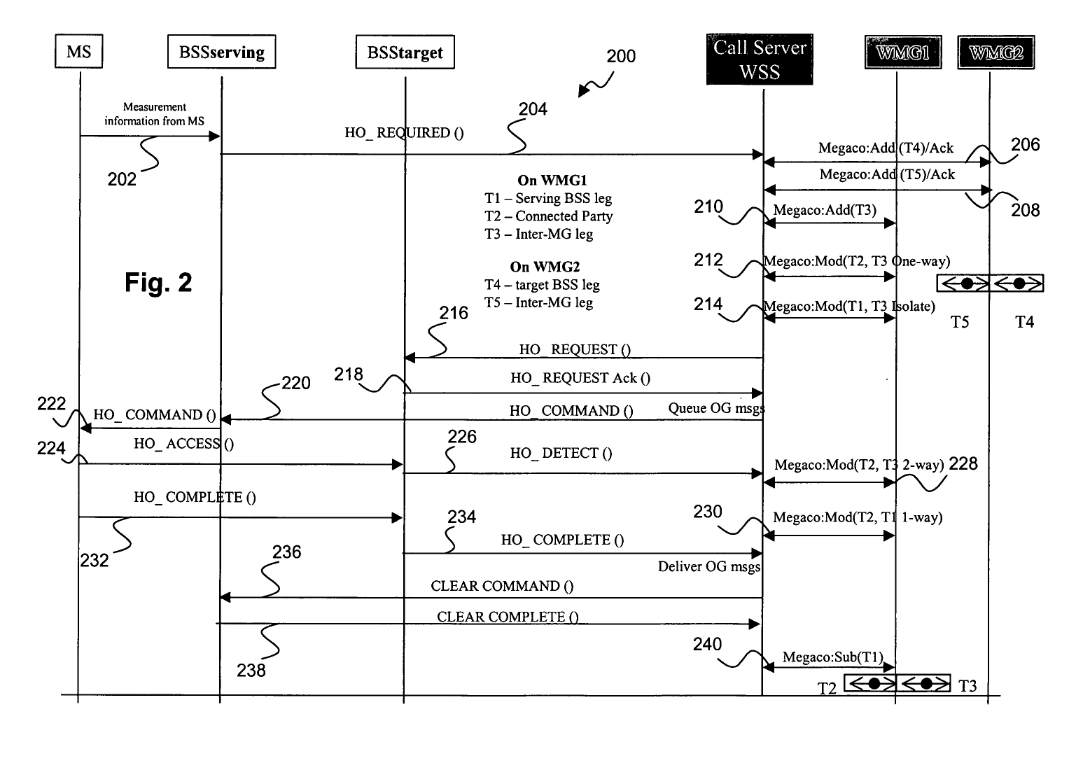

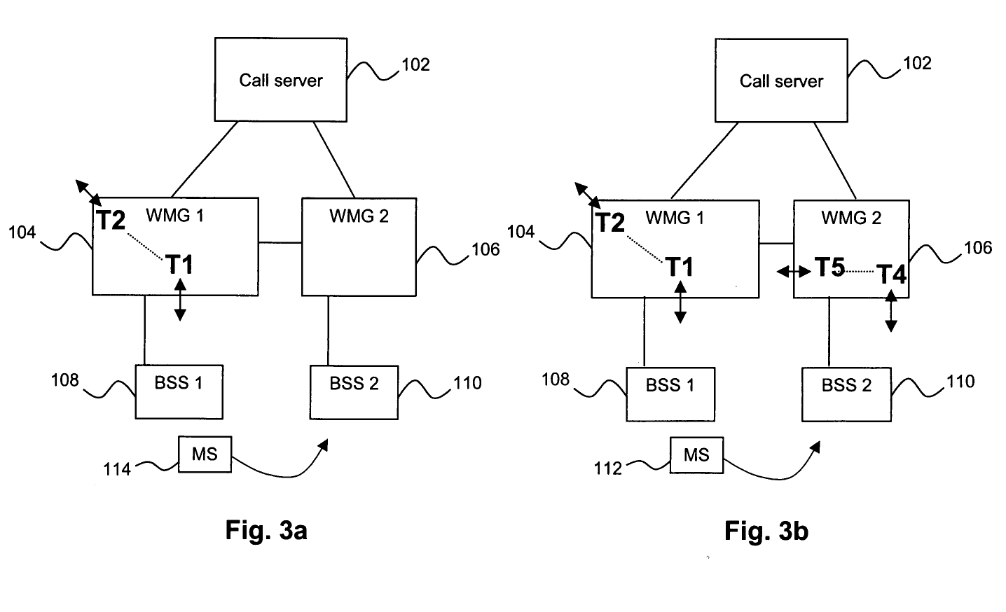

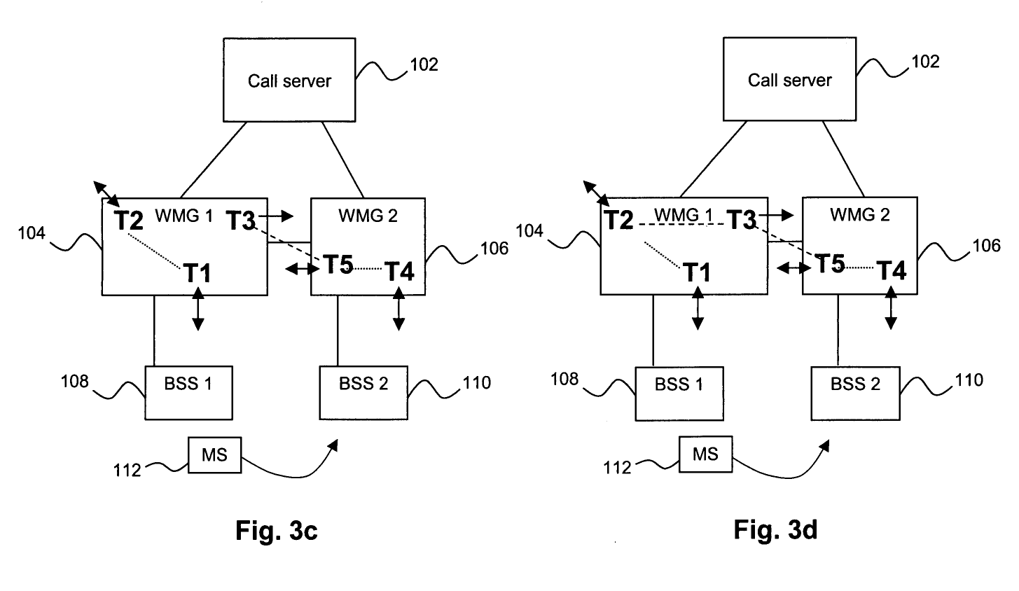

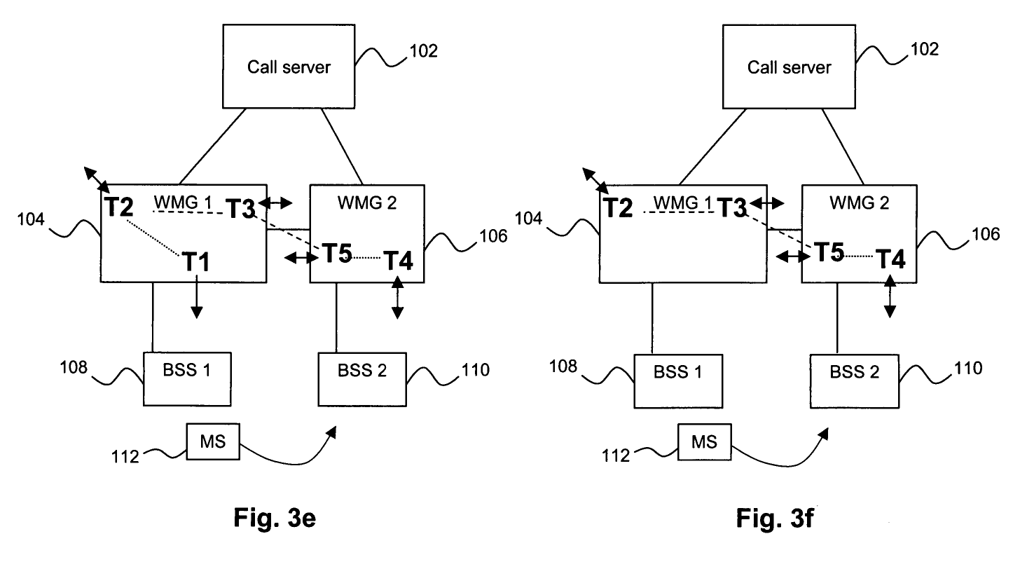

Referring now to FIG. 2 and with additional reference to FIGS. 3a-3f, in one embodiment, an exemplary call flow diagram 200 is illustrated for handing over the mobile device 112 of FIG. 1 from Region A to Region B. The call flow 200 illustrates a scenario where the connection between the WMGs 104, 106 is a TDM connection (e.g., the voice is carried between the two WMGs 102, 104 using Voice over TDM). For purposes of reference, the letter “T” is used to denote the type of connection point established at each of the WMGs.

Prior to the call flow of FIG. 2, as illustrated in FIG. 3a, two bi-directional termination points T1 and T2 may be established within the WMG 104. The termination points T1 and T2 may be used to establish a call path through the WMG. Each termination point T1, T2 interfaces with one neighboring network entity handling the bearer. For example, T1 interfaces with the BSS 108, while T2 interfaces with equipment (not shown) handling a caller connected to the mobile 112. Once the T1 and T2 termination points are established, a call context may be created to link the two termination points and to establish a bi-directional communication path across the WMG 104.

Referring again to FIG. 2, measurement information may be transferred between the mobile 112 and the BSS 108 (i.e., the serving BSS) in step 202. With additional reference to FIG. 3b, when a HO_Required message is received at the call server 102 (step 204), the call server may establish two bi-directional termination points T4 and T5 (steps 206, 208) in the WMG 106 that is serving the Region B (e.g., the region into which the mobile 112 is moving). The termination point T4 may be used to connect the bearer path between WMG 106 and the BSS 110 (i.e., the target BSS), and the termination point T5 may be used to connect the bearer path between WMG 106 and WMG 104.

In step 210 and with additional reference to FIG. 3c, the call server 102 may order WMG 104 to establish a single-direction termination point T3 directed towards the WMG 106 to connect WMG 104 with termination point T5 of WMG 106. T3 may be established in a uni-directional communication mode to avoid having voice signals coming from the mobile 112 to T3 looping back to the serving BSS 108 through the T1 termination point which is part of the (T1, T2) context already established before the handoff is initiated.

In step 212 and with additional reference to FIG. 3d, the call server 102 may order WMG 104 to modify the termination point T2 by adding a connection to T3. Accordingly, two contexts may exist in WMG 104: (T1,T2) with both T1 and T2 bi-directional, and (T2,T3) with T3 in a uni-directional communication mode towards WMG 106.

In steps 216, 218, 220, 222, 224, and 226 of FIG. 2, and with additional reference to FIG. 3e, a series of handoff messages are passed between the call server 204, target BSS 110, serving BSS 108, and mobile 112. Once a HO_Detect message (step 226) is received at the call server 102, the call server sends messages to WMG 104 indicating that the T3 termination point is to be modified to bi-directional (step 228) and the T1 termination point is to be modified to uni-directional (step 230). It is noted that T1 may not be deleted at this time so that it can be quickly re-modified to bi-directional in case the HO_Complete message is not received at the call server 102.

In steps 232, 234, a handoff complete message (HO_Complete) may be sent from the mobile 112 to the call server 102 via the target BSS 110. When the HO_Complete message is received by the call server 102, it is safe to delete T1 at WMG 104 in step 240 (as illustrated in FIG. 3f). Accordingly, the voice path comes into WMG 104 at T2, goes out at T3 towards WMG 106, enters WMG 106 at T5, and is sent to the BSS 110 via the termination point T4. In the present example, WMG 104 is known as the anchor WMG that routes the call from the connected party to the target WMG 106.

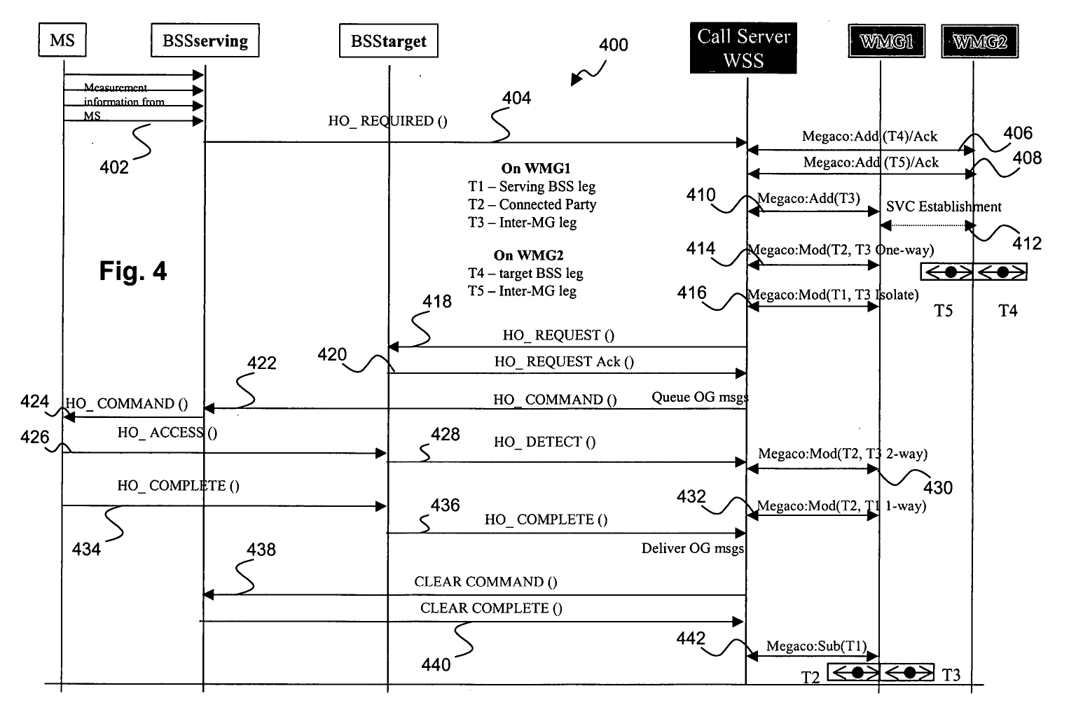

Referring now to FIG. 4, in another embodiment, an exemplary call flow diagram 400 is illustrated for handing over the mobile device 112 of FIG. 1 from Region A to Region B. The call flow 400 illustrates a scenario where the connection between the WMGs 104, 106 is an ATM connection (e.g., the voice is carried between the two WMGs 102, 104 using Voice over ATM). For purposes of reference, the letter “T” is used to denote the type of connection point established at each of the WMGs. The call flow 400 is similar to the method illustrated with reference to FIG. 2, except that the call server 102 may establish a switched virtual channel (SVC) for carrying voice over ATM between the WMGs once the T3 termination point is established.

Prior to the call flow of FIG. 4, two bi-directional termination points T1 and T2 may be established within the WMG 104. The termination points T1 and T2 may be used to establish a call path through the WMG. Each termination point T1, T2 interfaces with one neighboring network entity handling the bearer. For example, T1 interfaces with the BSS 108, while T2 interfaces with equipment (not shown) handling a caller connected to the mobile 112. Once the T1 and T2 termination points are established, a call context may be created to link the two termination points and to establish a bi-directional communication path across the WMG 104.

Measurement information may be transferred between the mobile 112 and the BSS 108 (i.e., the serving BSS) in step 402. When a HO_Required message is received at the call server 102 (step 404), the call server may establish two bi-directional termination points T4 and T5 (steps 406, 408) in the WMG 106 that is serving the Region B (e.g., the region into which the mobile 112 is moving). The termination point T4 may be used to connect the bearer path between WMG 106 and the BSS 110 (i.e., the target BSS), and the termination point T5 may be used to connect the bearer path between WMG 106 and WMG 104.

In step 410, the call server 102 may order WMG 104 to establish a single-direction termination point T3 directed towards the WMG 106 to connect WMG 104 with termination point T5 of WMG 106. T3 may be established in a uni-directional communication mode to avoid having voice signals coming from the mobile 112 to T3 looping back to the serving BSS 108 through the T1 termination point which is part of the (T1, T2) context already established before the handoff is initiated. In step 412, a SVC may be established between the WMGs 104, 106 to carry voice data.

In step 414, the call server 102 may order WMG 104 to modify the termination point T2 by adding a connection to T3. Accordingly, two contexts may exist in WMG 104: (T1,T2) with both T1 and T2 bi-directional, and (T2,T3) with T3 in a uni-directional communication mode towards WMG 106.

In steps 418, 420, 422, 424, 426, and 428, a series of handoff messages are passed between the call server 204, target BSS 110, serving BSS 108, and mobile 112. Once a HO_Detect message (step 428) is received at the call server 102, the call server sends messages to WMG 104 indicating that the T3 termination point is to be modified to bi-directional (step 430) and the T1 termination point is to be modified to uni-directional (step 432). It is noted that T1 may not be deleted at this time so that it can be quickly re-modified to bi-directional in case the HO_Complete message is not received at the call server 102.

In steps 434, 436, a handoff complete message (HO_Complete) may be sent from the mobile 112 to the call server 102 via the target BSS 110. When the HO_Complete message is received by the call server 102, it is safe to delete T1 at WMG 104 in step 442. Accordingly, the voice path comes into WMG 104 at T2, goes out at T3 towards WMG 106, enters WMG 106 at T5, and is sent to the BSS 110 via the termination point T4. In the present example, WMG 104 is known as the anchor WMG that routes the call from the connected party to the target WMG 106.

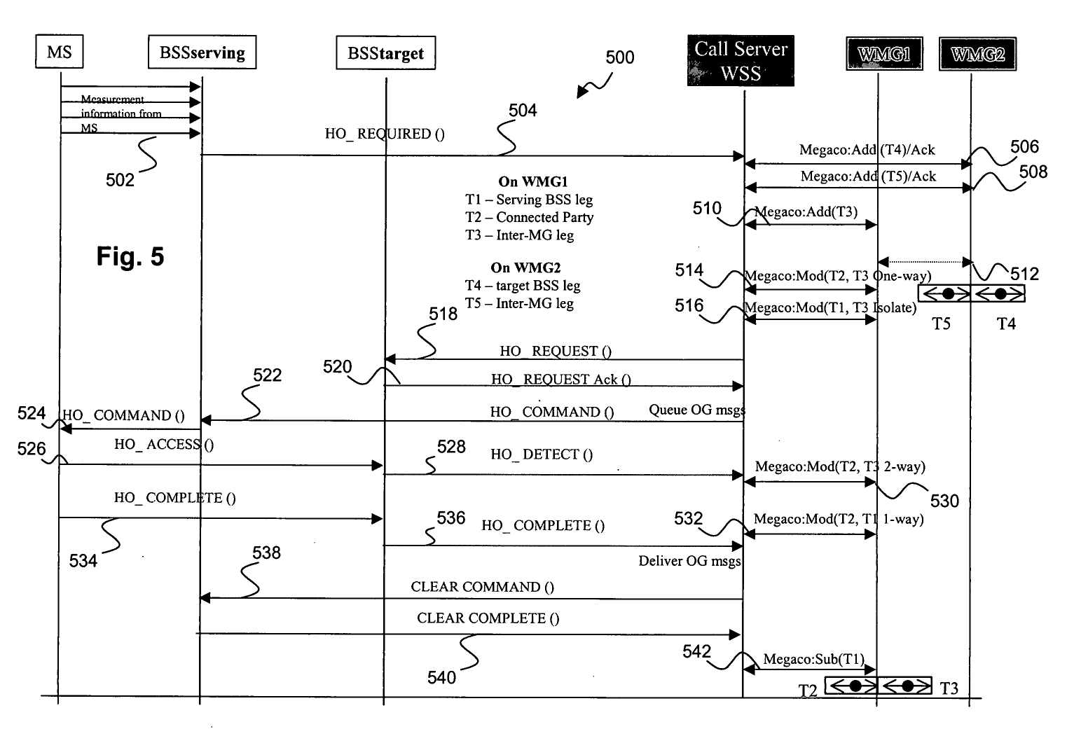

Referring now to FIG. 5, in still another embodiment, an exemplary call flow diagram 500 is illustrated for handing over the mobile device 112 of FIG. 1 from Region A to Region B. The call flow 500 illustrates a scenario where the connection between the WMGs 104, 106 is an IP connection (e.g., the voice is carried between the two WMGs 102, 104 using Voice over IP). For purposes of reference, the letter “T” is used to denote the type of connection point established at each of the WMGs. The call flow 500 is similar to the method illustrated with reference to FIG. 4, except that the call server 102 may establish an IP connection for carrying voice over IP between the WMGs 104, 106 once the T3 termination point is established

Prior to the call flow of FIG. 5, two bi-directional termination points T1 and T2 may be established within the WMG 104. The termination points T1 and T2 may be used to establish a call path through the WMG. Each termination point T1, T2 interfaces with one neighboring network entity handling the bearer. For example, T1 interfaces with the BSS 108, while T2 interfaces with equipment (not shown) handling a caller connected to the mobile 112. Once the T1 and T2 termination points are established, a call context may be created to link the two termination points and to establish a bi-directional communication path across the WMG 104.

Measurement information may be transferred between the mobile 112 and the BSS 108 (i.e., the serving BSS) in step 502. When a HO_Required message is received at the call server 102 (step 504), the call server may establish two bi-directional termination points T4 and T5 (steps 506, 508) in the WMG 106 that is serving the Region B (e.g., the region into which the mobile 112 is moving). The termination point T4 may be used to connect the bearer path between WMG 106 and the BSS 110 (i.e., the target BSS), and the termination point T5 may be used to connect the bearer path between WMG 106 and WMG 104.

In step 510, the call server 102 may order WMG 104 to establish a single-direction termination point T3 directed towards the WMG 106 to connect WMG 104 with termination point T5 of WMG 106. T3 may be established in a uni-directional communication mode to avoid having voice signals coming from the mobile 112 to T3 looping back to the serving BSS 108 through the T1 termination point which is part of the (T1,T2) context already established before the handoff is initiated. In step 512, an IP connection may be established between the WMGs 104, 106 to carry voice data.

In step 514, the call server 102 may order WMG 104 to modify the termination point T2 by adding a connection to T3. Accordingly, two contexts may exist in WMG 104: (T1,T2) with both T1 and T2 bi-directional, and (T2,T3) with T3 in a uni-directional communication mode towards WMG 106.

In steps 518, 520, 522, 524, 526, and 528, a series of handoff messages are passed between the call server 204, target BSS 110, serving BSS 108, and mobile 112. Once a HO_Detect message (step 528) is received at the call server 102, the call server sends messages to WMG 104 indicating that the T3 termination point is to be modified to bi-directional (step 530) and the T1 termination point is to be modified to one-way directional (step 532). It is noted that T1 may not be deleted at this time so that it can be quickly re-modified to bi-directional in case the HO_Complete message is not received at the call server 102.

In steps 534, 536, a handoff complete message (HO_Complete) may be sent from the mobile 112 to the call server 102 via the target BSS 110. When the HO_Complete message is received by the call server 102, it is safe to delete T1 at WMG 104 in step 542. Accordingly, the voice path comes into WMG 104 at T2, goes out at T3 towards WMG 106, enters WMG 106 at T5, and is sent to the BSS 110 via the termination point T4. In the present example, WMG 104 is known as the anchor WMG that routes the call from the connected party to the target WMG 106.

As described above, the present disclosure describes scenarios where the bearer-based anchor WMG 104 routes the voice path towards the target WMG 106. In some embodiments, if there were a subsequent handover to a third WMG (not shown), then a new leg corresponding to the bearer path from the anchor WMG 104 to the third WMG may be set up and the second WMG 106 may be dropped from the end-to-end voice connection.

Accordingly, following a ‘basic’ inter-WMG handover, the present disclosure contemplates subsequent WMG handovers. These scenarios might mirror subsequent handback to the original WMG 106 (e.g., where the mobile moves back into the region serviced by the anchor WMG) or a subsequent handover to a third WMG.

Referring now to FIG. 8, in yet another embodiment, an exemplary network architecture 600 illustrates the architecture 100 of FIG. 1 with an additional WMG 602 connected to an additional BSS 604. It is understood that various termination points may be created and deleted as described in the preceding figures.

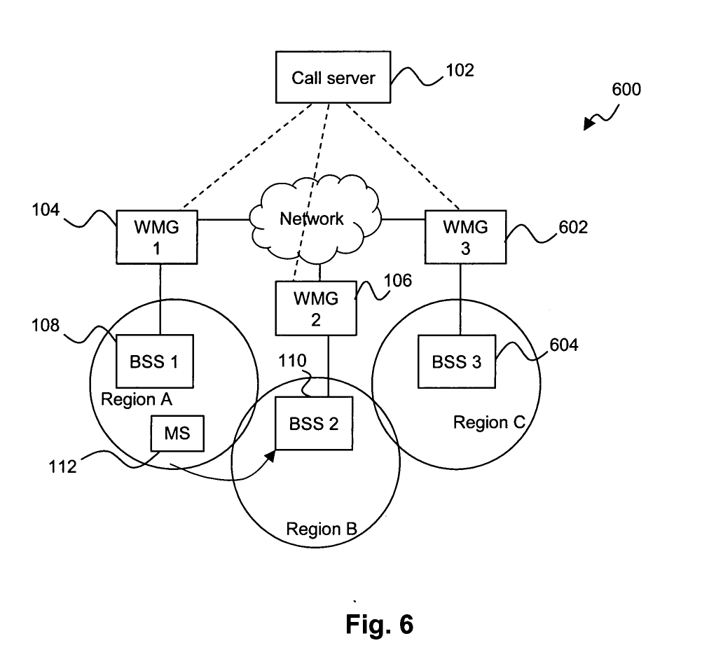

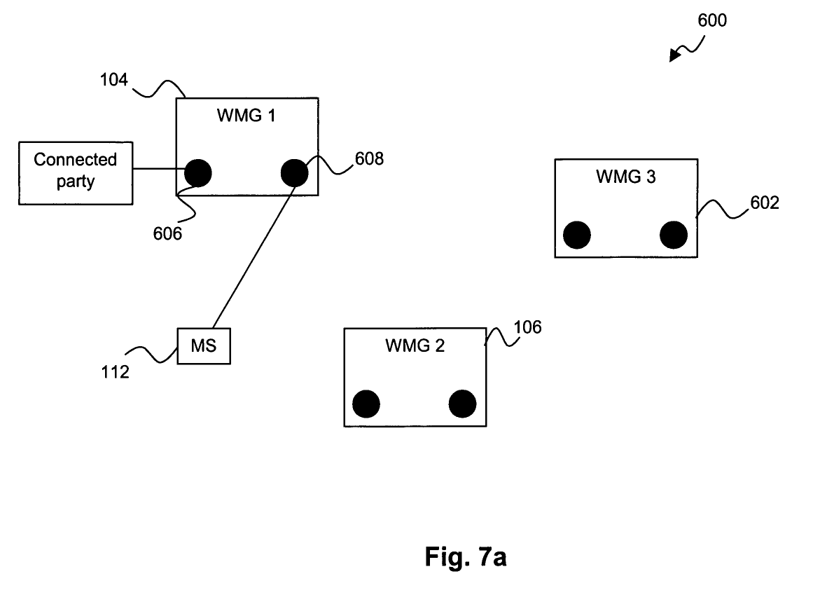

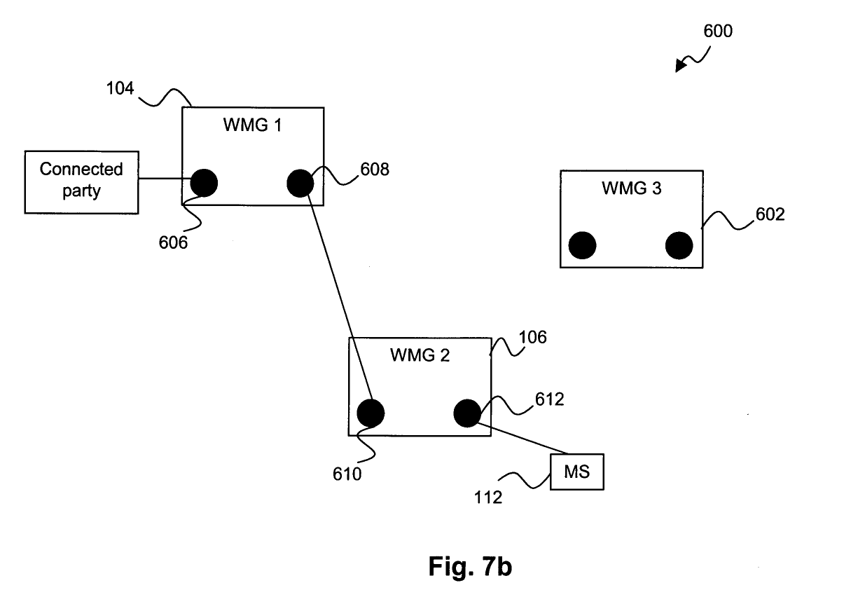

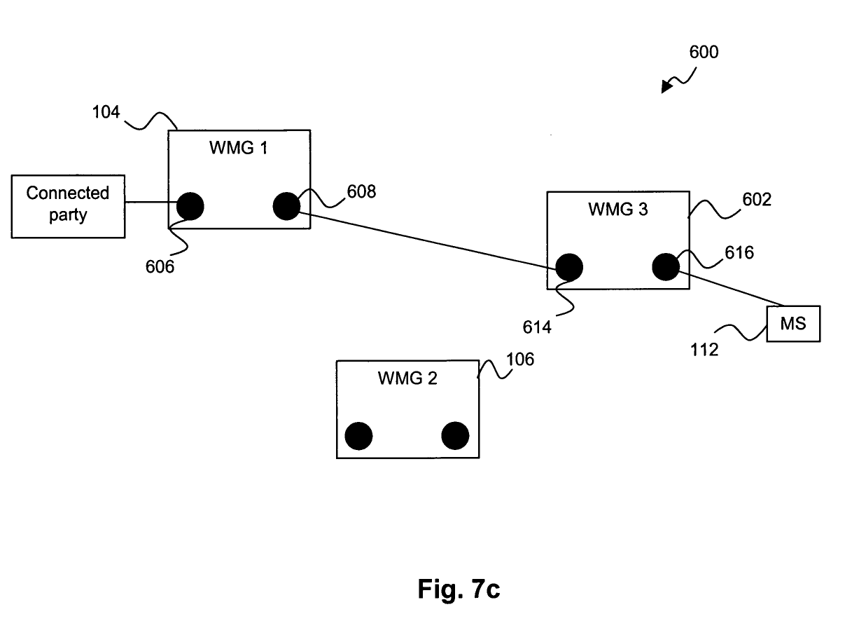

With additional reference to FIG. 7a, the architecture 600 is illustrated with only the WMGs 104, 106, and 602. A connected party is connected to a termination point 606 in the WMG 104, which routes the call to the mobile 112 (which is in Region A of FIG. 6) via a termination point 608.

With additional reference to FIG. 7b, when the mobile moves into Region B (FIG. 6), a handoff occurs to the WMG 106. The connected party remains connected to the termination point 606 in the WMG 104, which routes the call to a termination point 610 of the WMG 106. The WMG 106 is connected to the mobile 112 via a termination point 612. The handoff may occur as previously described using the WMG 104 as the anchor WMG.

With additional reference to FIG. 7c, when the mobile moves into Region C (FIG. 6), a handoff occurs to the WMG 602. The connected party remains connected to the termination point 606 in the WMG 104, which routes the call to a termination point 614 of the WMG 602. The WMG 602 is connected to the mobile 112 via a termination point 616. Accordingly, the WMG 104 is the anchor WMG, which does not change, while the target WMG changes from the WMG 106 to the WMG 602 as the mobile 112 is handed off. It is understood that termination points may be created or deleted as needed, and that more termination points may be used than are illustrated. Furthermore, the presence of termination points in each WMG is for purposes of illustration only and does not indicate that such termination points are always present.

The above disclosure provides many different embodiments, or examples, for implementing the disclosure. However, specific examples, and processes are described to help clarify the disclosure. These are, of course, merely examples and are not intended to be limiting. For instance, even though examples using only two and three WMGs have been used throughout the disclosure, the present disclosure may be applied to any number of WMGs that may be controlled by a single call server. Additionally, although ATM, TDM, and IP interfaces have been used as exemplary bearer interfaces between different WMGs in the network, the present disclosure may be applied to any bearer technology that can be used for voice or data traffic. Additionally, although a single BSS serviced by a single WMG is used for purposes of illustration, the present disclosure may be applied when multiple BSS are connected and serviced by a single WMG. Further more, even though MEGACO is used to describe the interface and signaling between the call server and the WMG, the present disclosure may be applied to any control protocol used between a call server and a given media gateway.

In addition, the present disclosure applies to any wireless technology that may use a handoff operation and management when the mobile moves out of wireless coverage into another area. The present disclosure may also be applied to any mobile device that operates in a wireless network. Furthermore, although one type of call is used for purposes of illustration, the present disclosure may be applied to any call involving the mobile station such as a mobile to mobile call, a land to mobile call, a mobile to IVR system call, and others.

For purposes of simplicity, the examples used above illustrate the various WMGs as being directly connected to each other. However, it is understood that the present disclosure may be applied if the WMGs are connected to each other through a series of network nodes that act as relay network entities. Additionally, even though voice was used as an example to describe the disclosure, the present disclosure applies to any application or service the mobile can use or handle such as packet data services, e-mail, Short Message Service, multimedia services, and others.

It is understood that one or more (including all) of the elements/steps of the present disclosure may be implemented using software and/or hardware to develop the softswitch, which may then be deployed in a wireless network at appropriate locations with the proper connections.

Accordingly, while the disclosure has been particularly shown and described with reference to specific examples, it will be understood by those skilled in the art that various changes in form and detail may be made therein without departing from the spirit and scope of the disclosure. It is understood that several modifications, changes and substitutions are intended in the foregoing disclosure and in some instances some features of the disclosure will be employed without a corresponding use of other features. For example, various steps in the above described methods may be combined, further divided, or eliminated entirely. Furthermore, steps may be performed in any order, and steps described with respect to different methods may be combined into a single method. In addition, data flows other than those illustrated may be used to provide identical or similar functionally. Accordingly, it is appropriate that the appended claims be construed broadly and in a manner consistent with the scope of the disclosure.

What is claimed is:

1. A method for performing a handoff of a mobile device from a first wireless media gateway (WMG) to a second WMG, wherein the first and second WMGs are controlled by a single call server, and wherein the first WMG includes first and second bi-directional termination points connecting the first WMG to the mobile device and another party, respectively, the method comprising:
establishing bi-directional fourth and fifth termination points in the second WMG to prepare the second WMG for communicating with the mobile device and the first WMG, respectively;
establishing a uni-directional third connection point in the first WMG and connecting the third termination point to the fifth termination point in the second WMG;
connecting the second and third termination points;
converting the third termination point from uni-directional to bi-directional; and
converting the first termination point from bi-directional to uni-directional, wherein communications to the mobile device from the other party are routed through the second, third, fifth, and fourth termination points, respectively.

2. The method of claim 1 further comprising deleting the first termination point when the handoff is complete.

3. The method of claim 1 further comprising converting the first termination point back to bi-directional from uni-directional if the handoff fails.

4. The method of claim 1 further comprising creating an internet protocol connection between the first and second WMGs to carry the communications between the mobile device and the other party.

5. The method of claim 1 further comprising creating a switched virtual channel between the first and second WMGs to carry the communications between the mobile device and the other party.

6. The method of claim 1 wherein the third termination point is converted to bi-directional only after a handoff detect message is received by the call server.

7. A method for performing a handoff of a mobile device from a first wireless media gateway (WMG) to a second WMG, wherein the first and second WMGs are controlled by a single call server, and wherein the first WMG is in communication with the mobile device through a first base station subsystem (BSS) connected to the first WMG via a bi-directional first termination point and is in communication with a connected party via a bi-directional second termination point, the method comprising:
sending at least one message from the call server to the second WMG to create bi-directional fourth and fifth termination points to prepare the second WMG for communicating with the mobile device via a second BSS and with the first WMG, respectively;
sending at least one message from the call server to the first WMG to establish a uni-directional third termination point in the first WMG, wherein the first and second WMGs are connected via the third and fifth termination points;
sending at least one message from the call server to the first WMG to connect the second and third termination points; and
sending at least one message from the call server to the first WMG to convert the third termination point from uni-directional to bi-directional and the first termination point from bi-directional to uni-directional.

8. The method of claim 7 further comprising sending at least one message from the call server to the first WMG to delete the first termination point when the call server receives a message indicating that the handoff is complete.

9. The method of claim 7 further comprising creating an internet protocol connection between the first and second WMGs to carry the communications between the mobile device and the other party after the third termination point is established.

10. The method of claim 7 further comprising creating a switched virtual channel between the first and second WMGs to carry the communications between the mobile device and the other party after the third termination point is established.

11. The method of claim 7 further comprising:
handing off the mobile device to a third WMG controlled by the call server by connecting the third termination point with a sixth termination point created in the third WMG; and
establishing a seventh termination point connected to the sixth termination point, wherein the seventh termination point connects the third WMG to a third BSS in communication with the mobile device.

12. A system for managing a handoff of a mobile device, the system comprising:
a call server;
first and second wireless media gateways (WMGs) controlled by the call server and accessible to one another;
first and second base station subsystems (BSSs) connected to the first and second WMGs, respectively, and
a plurality of computer executable instructions for execution within the system, the instructions including:
instructions for establishing a communication channel between the mobile device and a connected party through the first WMG via a context created using first and second termination points, respectively;
instructions for sending at least one message from the call server to the second WMG to create fourth and fifth termination points to prepare the second WMG for communicating with the mobile device and the first WMG, respectively;
instructions for sending at least one message from the call server to the first WMG to establish a third connection point in the first WMG, wherein the first and second WMGs are connected via the third and fifth termination points;
instructions for sending at least one message from the call server to the first WMG to create a context using the second and third termination points; and
instructions for sending at least one message from the call server to the first WMG to ensure that the third termination point is bi-directional and the first termination point is uni-directional.

13. The system of claim 12 further comprising instructions for sending at least one message from the call server to the first WMG to delete the first termination point.

14. The system of claim 13 wherein the first termination point is deleted only after a message indicating that the handoff is successful is received by the call server.

15. The system of claim 12 wherein communications between the first and second WMGs use voice over internet protocol (IP), and wherein the system further comprises instructions for creating an IP connection between the first and second WMGs.

16. The system of claim 15 wherein the IP connection is created after the third termination point is established.

17. The system of claim 12 wherein communications between the first and second WMGs use a voice over asynchronous transfer mode connection, and wherein the system further comprises instructions for creating a switched virtual channel between the first and second WMGs.

18. The system of claim 17 wherein the switched virtual channel is created after the third termination point is established.

19. The system of claim 12 wherein communications between the first and second WMGs use a voice over time division multiplexing connection.

20. A method for handing off a mobile device from a first wireless media gateway (WMG) to a second WMG, wherein the first and second WMGs are controlled by a single call server, and wherein the first WMG includes first and second termination points connecting the first WMG to the mobile device and another party, respectively, the method comprising:
creating fourth and fifth termination points in the second WMG to provide an interface for the second WMG to communicate with the mobile device and the first WMG, respectively;
establishing a third termination point in the first WMG, wherein the third and fifth termination points link the first and second WMGs;
creating a context with the second and third termination points; and
making the third termination point bi-directional.

21. The method of claim 20 further comprising, if the first termination point is bi-directional, converting the first termination point from bi-directional to uni-directional.

22. The method of claim 20 wherein the mobile device is handed off to a third WMG controlled by the call server, the method further comprising:
creating sixth and seventh termination points in the third WMG to provide an interface for the third WMG to communicate with the mobile device and the first WMG, respectively; and
linking the third termination point to the seventh termination point to provide a communication channel between the mobile device and the other party.

23. The method of claim 20 wherein the mobile device is handed back to the first WMG, the method further comprising:
if the first termination point is uni-directional, converting the first termination point from uni-directional to bi-directional; and
making the third termination point uni-directional.

24. The method of claim 23 further comprising deleting the third termination point after the mobile device is successfully handed back to the first WMG.

25. The method of claim 23 further comprising, if the first termination point does not exist, creating the first termination point.
